(19) United States
(12) Patent Application Publication
(10) Pub. No.: US 2024/0104239 A1
(43) Pub. Date: Mar. 28, 2024

(54) BLINDFOLD ANALYTICS

(71) Applicant: SparkBeyond Ltd., Natanya (IL)

(72) Inventors: Meir MAOR, Netanya (IL); Lotem KAPLAN, Tel Aviv (IL); Sagie DAVIDOVICH, Zikhron-Yaakov (IL); Ron KARIDI, Herzliya (IL); Amir RONEN, Haifa (IL)

(73) Assignee: SparkBeyond Ltd., Natanya (IL)

(21) Appl. No.: 17/950,213

(22) Filed: Sep. 22, 2022

(51) Int. Cl. G06F 21/62; G06N 5/04

(52) U.S. Cl. CPC G06F 21/6245; G06F 21/6209; G06N 5/045

(57) ABSTRACT

There is provided a method of dynamic adaptation of a graphical user interface for exploring sensitive data, comprising: dynamically creating a hidden data presentation by applying permissions to a dataset, for hiding records, obtaining a selection of a target variable via the GUI presenting the hidden data presentation, feeding the dataset and the target variable into a hypothesis engine that extracts hypothesis features from the dataset, tests correlations between the hypothesis features and the target variable, and selects a set of insight features from the hypothesis features according to the correlations, dynamically creating a hidden result presentation by propagating the permission to the portions of the dataset used to compute the insight features, and presenting within the GUI the hidden result presentation that presents the insight features and hides the portions of the dataset used to compute the insight features according to the permissions.

### FIELD AND BACKGROUND OF THE INVENTION

The present invention, in some embodiments thereof, relates to data security and, more specifically, but not exclusively, to systems and methods for analysis of data while maintaining security of the data.

Data may be stored in many different databases, hosted on different servers, and managed by different entities. It is difficult to maintain security of the data when data analysis requires accessing different sensitive data elements on different servers and/or managed by different entities. For example, each server and/or entity may maintain their own set of user credentials allowed to access the data. In such an environment, Accessing data on multiple servers requires setting up user accounts on each of the multiple servers.

### SUMMARY OF THE INVENTION

According to a first aspect, a computer implemented method of dynamic adaptation of a graphical user interface (GUI) for exploring sensitive data, comprises: dynamically creating a hidden data presentation by applying permissions to a dataset, for hiding a plurality of records, obtaining a selection of a target variable via the GUI presenting the hidden data presentation, feeding the dataset and the target variable into a hypothesis engine that extracts a plurality of hypothesis features from the dataset, tests correlations between the plurality of hypothesis features and the target variable, and selects a set of insight features from the plurality of hypothesis features according to the correlations, dynamically creating a hidden result presentation by propagating the permission to the portions of the dataset used to compute the insight features, and presenting within the GUI the hidden result presentation that presents the insight features and hides the portions of the dataset used to compute the insight features according to the permissions.

According to a second aspect, a system for dynamic adaptation of a graphical user interface (GUI) for exploring sensitive data, comprises: at least one processor executing a code for: dynamically creating a hidden data presentation by applying permissions to a dataset, for hiding a plurality of records, obtaining a selection of a target variable via the GUI presenting the hidden data presentation, feeding the data and the target variable into a hypothesis engine that extracts a plurality of hypothesis features from the dataset, tests correlations between the plurality of hypothesis features and the target variable, and selects a set of insight features from the plurality of hypothesis features according to the correlations, dynamically creating a hidden result presentation by propagating the permission to the portions of the dataset used to compute the insight features, and presenting within the GUI the hidden result presentation that presents the insight features and hides the portions of the dataset used to compute the insight features according to the permissions.

According to a third aspect, a non-transitory medium storing program instructions for dynamic adaptation of a graphical user interface (GUI) for exploring sensitive data, which, when executed by at least one processor, cause the at least one processor to: dynamically create a hidden data presentation by applying permissions to a dataset, for hiding a plurality of records, obtain a selection of a target variable via the GUI presenting the hidden data presentation, feed the data and the target variable into a hypothesis engine that extracts a plurality of hypothesis features from the dataset, tests correlations between the plurality of hypothesis features and the target variable, and selects a set of insight features from the plurality of hypothesis features according to the correlations, dynamically create a hidden result presentation by propagating the permission to the portions of the dataset used to compute the insight features, and present within the GUI the hidden result presentation that presents the insight features and hides the portions of the dataset used to compute the insight features according to the permissions.

In a further implementation form of the first, second, and third aspects, the dataset fed into the hypothesis engine includes data that is hidden during presentation of the hidden data presentation in the GUI.

In a further implementation form of the first, second, and third aspects, the dataset comprises a primary dataset, the permissions comprise primary permissions, and further comprising: creating at least one secondary hidden data presentation by applying secondary permissions to at least one secondary dataset, for hiding a plurality of secondary records, wherein each secondary dataset of a plurality of secondary datasets is associated with a different set of secondary permissions, and presenting the at least one secondary hidden data presentation within the GUI, wherein the at least one secondary dataset is fed with the primary dataset and the target variable into the hypothesis engine that extracts the plurality of hypothesis features from the at least one secondary dataset and the primary dataset.

In a further implementation form of the first, second, and third aspects, further comprising: obtaining, via the GUI, a plurality of links between variables of the primary dataset and variables of the at least one secondary dataset, wherein variables linked by the plurality of links define a dynamic dataset, wherein the dynamic dataset is fed into the hypothesis engine for extracting the plurality of hypothesis features from the dynamic dataset.

In a further implementation form of the first, second, and third aspects, further comprising converting an insight feature from a mathematical representation of computation of the insight feature, to a human readable text format, and presenting the human readable text format in the hidden result presentation.

In a further implementation form of the first, second, and third aspects, further comprising: extracting at least one explanatory variable of the dataset used for computing the insight features, wherein propagating comprises applying the permissions to the at least one explanatory variable, and presenting within the GUI the at least one explanatory variable with applied permissions.

In a further implementation form of the first, second, and third aspects, further comprising: obtaining, via the GUI, at least one transformation applied to at least one variable of the dataset, prior to the feeding, applying the at least one transformation to the dataset to obtain a transformed dataset, presenting within the GUI, the at least one transformation and a presentation of the transformed dataset applied permissions, and wherein feeding comprises feeding the transformed dataset into the hypothesis engine, wherein features are extracted from the transformed dataset.

In a further implementation form of the first, second, and third aspects, the at least one transformation, the applying the at least one transformation, the feeding, the dynamically creating the hidden result presentation, and the presenting the hidden result presentation are dynamically iterated, wherein in each iteration a different adapted at least one transformation is obtained for generating adapted insight features.

In a further implementation form of the first, second, and third aspects, further comprising: applying the insight features to the plurality of records of the dataset to obtain sets of extracted features, creating a training dataset of a plurality of records, wherein a record of the training dataset includes a set of extracted features of a record of the dataset and ground truth of a value of the target variable of the record of the dataset, and training a machine learning model on the training dataset.

In a further implementation form of the first, second, and third aspects, further comprising: applying the insight features to input data to obtain extracted features for the input data, feeding the extracted features of the input data into the machine learning model, and obtaining a result value of the target variable as an outcome of the machine learning model.

In a further implementation form of the first, second, and third aspects, further comprising: obtaining a new primary dataset having a schema of the primary dataset, obtaining at least one new secondary dataset having a schema of at least one secondary dataset used to obtain the insight features, applying permissions to the new primary dataset and the at least one new secondary dataset for hiding data during presentation, linking the new primary dataset with the at least one new secondary dataset for creating a new dynamic dataset, applying the insight features to the new dynamic dataset to obtain extracted features, feeding the extracted features into the machine learning model, and obtaining a result value of the target variable as an outcome of the machine learning model.

In a further implementation form of the first, second, and third aspects, variables of the dataset to which permissions are applied are propagated to underlying data for computing the insight features, wherein the underlying data is hidden during presentation of the hidden result presentation in the GUI.

In a further implementation form of the first, second, and third aspects, at least one insight feature computed by aggregating data from a subset of the plurality of records to which permissions are applied, is presented in the GUI without hiding.

In a further implementation form of the first, second, and third aspects, insight features are not hidden and presented within the GUI, and values of the insight features computed from the dataset are hidden by propagating the permissions from the values of the dataset used to compute the values of the insight features to the values of the insight features.

In a further implementation form of the first, second, and third aspects, the hypothesis engines extracts a plurality of hypothesis features by applying different combinations of functions to the datasets, and selects the set of insight features having a correlation above a threshold and/or having highest ranked correlations.

In a further implementation form of the first, second, and third aspects, further comprising: obtaining, via the GUI, a selection of an insight feature computed from a portion of the dataset hidden according to the permissions, and presenting, within the GUI, computed correlations between the selected insight feature and the target variable.

In a further implementation form of the first, second, and third aspects, the insight features presented in the hidden result presentation include explanatory variables that explain changes in the target variable, while hiding values of the explanatory variable and hiding computations performed based on the explanatory variable.

In a further implementation form of the first, second, and third aspects, permissions are defined according to user credentials.

In a further implementation form of the first, second, and third aspects, the permissions are selected from a group consisting of: hiding all data of the dataset except for the data schema, partially hiding data of the dataset and allowing viewing of the other data, no hiding of any data of the dataset.

In a further implementation form of the first, second, and third aspects, the dataset comprises a table of columns, and the permissions are defined for at least one of: the table as a whole, and per column.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for dynamic creation of a hidden data presentation and/or hidden result presentation, in accordance with some embodiments of the present invention;

FIG. 2A is a flowchart of a method of dynamic creation of a hidden data presentation and/or hidden result presentation, in accordance with some embodiments of the present invention;

FIG. 2B is an exemplary method for training a machine learning model and/or inference by the machine learning model (also referred to herein as a predictive model) using the insight features, in accordance with some embodiments of the present invention;

FIG. 3 is a dataflow diagram depicting exemplary dataflow for generating insight features from sensitive data hidden in a presentation to a user, in accordance with some embodiments of the present invention;

FIG. 4 is another dataflow diagram depicting exemplary dataflow for generating insight features from sensitive data hidden in a presentation to a user, in accordance with some embodiments of the present invention;

FIG. 5 is a schematic of an exemplary GUI for defining permissions for different users (e.g., groups of users), in accordance with some embodiments of the present invention;

FIG. 6 is a schematic of an exemplary GUI for defining permissions for a user (e.g., user) 604, in accordance with some embodiments of the present invention;

FIG. 7 is a schematic of an exemplary GUI presenting data of a dataset without applied permissions, in accordance with some embodiments of the present invention;

FIG. 8, which is a schematic of an exemplary GUI presenting data of a dataset to which permissions are applied, in accordance with some embodiments of the present invention;

FIG. 9 is a schematic of another exemplary GUI presenting data of a dataset without applied permissions, in accordance with some embodiments of the present invention;

FIG. 10 is a schematic of an exemplary GUI presenting data of a dataset to which permissions are applied, in accordance with some embodiments of the present invention;

FIG. 11 is a schematic of an exemplary GUI presenting data of a dataset to which permissions are applied, for designation of a target variable by a user, in accordance with some embodiments of the present invention;

FIG. 12 is a schematic of an exemplary GUI presenting data of a dataset to which permissions are applied, for linking by a user to one or more other datasets, in accordance with some embodiments of the present invention;

FIG. 13 is a schematic of an exemplary GUI presenting insight features generated by the hypothesis engine, in accordance with some embodiments of the present invention;

FIG. 14 is a schematic of an exemplary GUI presenting additional details of a selected insight feature generated by the hypothesis engine without applying restrictions, in accordance with some embodiments of the present invention;

FIG. 15 is a schematic of an exemplary GUI presenting additional details of a selected insight feature generated by the hypothesis engine to which restrictions are applied, in accordance with some embodiments of the present invention; and

FIG. 16 is a schematic of another exemplary GUI presenting additional details of a selected insight feature generated by the hypothesis engine without applying restrictions, in accordance with some embodiments of the present invention.

### DESCRIPTION OF SPECIFIC EMBODIMENTS OF THE INVENTION

The present invention, in some embodiments thereof, relates to data security and, more specifically, but not exclusively, to systems and methods for analysis of data while maintaining security of the data.

An aspect of some embodiments of the present invention relates to systems, methods, computing devices, and/or code instructions (stored on a data storage device and executable by one or more processors) for secure exploration of sensitive data, optionally by dynamic adaptation of a graphical user interface (GUI). Insights of the data may be obtained without revealing restricted portions of the data. A hidden data presentation is dynamically created by applying permissions to one or more datasets. The hidden data presentation selectively hides data of records, such that the user viewing the GUI cannot see the hidden data, for example, certain columns of data are hidden for selected users. A selection of a target variable, for example a column, is obtained via the GUI presenting the hidden data presentation. The dataset and the target variable are fed into a hypothesis engine. The data fed into the hypothesis engine includes data that is hidden during the presentation of the hidden presentation within the GUI. The hypothesis engine extracts multiple hypothesis features from the dataset, tests correlations between the hypothesis features and the target variable, and selects a set of insight features from the hypothesis features according to the correlations. A hidden result presentation is dynamically created by propagating the permission to the portions of the dataset used to compute the insight features. The hidden result presentation that presents the insight features and hides the portions of the dataset used to compute the insight features according to the permissions, is presented within the GUI. The insight features may be used, for example, to train a machine learning model and/or analyzed on their own to help understand the target variable.

Insight features may be found by transforming the multiple records of different datasets which may be linked together and/or aggregation of the data in order to find something with a high correlation with the target variable, to predict/explain the target variable. Metrics for the insight features may be computed, for example, amount of correlation of the insight feature with a key performance indicator (KPI).

At least some implementations of the systems, methods, computing devices, and/or code (stored on a data storage device and executable by a processor(s)) described herein address the technical problem of maintaining security of data (e.g., hiding sensitive data from an authorized user) while enabling a user (e.g., data scientist) to analyze the secure data to obtain insights about the data. At least some implementations described herein improve the technology of data security. At least some implementations described herein address the above mentioned technical problem, and/or improve the above mention technology, by hiding sensitive data from a user while allowing the user to explore datasets, for example, link datasets, and/or create handcrafted features. The user input is used to automatically generate insight features from the data which is hidden from the user.

At least some implementations described herein address the technical problem of graphical users interfaces (GUIs) which present sensitive data to a user to enable the user to analyze the data. The problem arises when the user wishes to analyze the data, but the data is restricted to that user. In such a case the user cannot analyze the data using the GUI. At least some implementations described herein improve the technology of GUIs. At least some implementations described herein address the above mentioned technical problem, and/or improve the above mention technology, by providing a GUI that generates a hidden data presentation by applying permission to one or more datasets. Even when all the data is hidden to the user, the GUI presents the schema of the dataset(s) to the user, which enables the user to select a target variable, link datasets, and/or view insight features computed from the restricted data.

At least some implementations described herein address the technical problem of maintaining security of data during a presentation of the data, optionally within a GUI, for enabling a user to manipulate the data in an effort to find insights within the data, for example, link between different datasets, and/or design hand crafted features (e.g., functions applied for manipulation of the data). At least some implementations described herein improve the technology of GUIs, by dynamically creating hidden presentations that apply permissions for hiding data of one or more datasets presented within the GUI. For example, only the schema is presented while the actual data is hidden, or some columns of data are hidden while other columns of data are presented while presenting the title of all columns including data with hidden data. The hidden presentation hides sensitive data from the user, while enabling the user to link between dataset, and/or design hand crafted features. Insight features are automatically computed from the sensitive data, without presenting the sensitive data to the user. The insight features, which are computed as an aggregation of the sensitive data and therefore do not provide any information on the actual sensitive data, may be presented within the GUI.

For example, for a given data analysis problem, and a diverse set of data sources that includes a main training set with a target/response variable, a data scientist formulates the data and approach needed for modeling the problem and coming up with insight features. Due to privacy and IP considerations the data scientists cannot always see all the full datasets but only some representations, or aggregations over the data that would maintain their integrity. The goal is to analyze the data such that the most informative insights are delivered to the stakeholders. In addition a set of features may be determined that is used for machine learning model building and/or predictions.

At least some implementations described herein address the technical problem of selecting data for generating a training dataset for training a machine learning model while securing the training data, for example, making the training data inaccessible to a user that links primary and secondary datasets used to generate the training dataset. At least some implementations of the systems, methods, computing devices, and/or code described herein improve the technology of training machine learning models by enabling a user to link data used to generate the training dataset while hiding sensitive data from the user.

In recent years, technology has become an inseparable part of every aspect of people's lives, and organizations today collect more data than ever before from every aspect of their operation, for example, from customer data to operational data. As the databases grow and the use of them become inseparable from the operation, new problems of privacy and data sharing emerge. This issue materializes in a few different forms, such as (i) personalization and privacy: sensitive data that may identify different individuals within the datasets; (ii) contractual based limitations—limited permissions to explore and leverage datasets within the organization; (iii) 3rd party data sources: data acquisition that can only be done through aggregative summaries.

Some examples of the technical problem are now described. A CPG company, as a business, wishes to optimize its revenue. Although the CPG company sells its products to retailers, the income eventually comes from individual customers that shop in the retailers' stores. That is, the CPG company is a B2B business, it needs the retailer to provide the B2C aspect, that forms a buffer between the CPG company and the consumer. As the CPG company tries to answer many operational questions, such as its market share per store, campaign performance, or customer preferences and segmentation based on shopping habits, it lacks the data to do so, since this information is held by the retailer. The retailer has data about the stores, shelf space, basket level information, customer identifiers, foot traffic, and competing products sales information. Even if the retailer and the CPG company agree to collaborate their efforts in optimizing sales and joint promotional campaigns, there is plenty of personal identifiable information (PII), and business IP data that cannot be shared as is for business and legal reasons. Therefore there is a technical problem of allowing entities (e.g., businesses, organizations) to collaborate and reach joint insights from their data, while maintaining privacy of their data.

In another example, medical data, by its nature, is sensitive and contains a lot of PII both directly through name, id, address, etc. and indirectly through medical facility, medical information, etc. In medical research, a researcher usually has access to data from the same medical facility, which implies a very small dataset, that is also biased in its nature. In order to reach a large enough dataset that accurately captures the medical condition, researchers from different medical facilities have to share their data. Due to the sensitivity of the data the different functions that work with the data cannot be exposed to the full data nor can they be able to identify individuals based on it. During a pandemic crisis, medical information around the globe has to be shared in order to quickly learn about the disease, its symptoms, eruption patterns, segment and flag the population for potentially high risk patients and the requirement of medical resources. However, data scientists that work with this data in order to model and identify those patterns, cannot be exposed to explicit identifiers on a patient level, due to privacy concerns. Important segmentation of high risk populations requires such sensitive data, such as age, gender, ethnicity, race, geo location, occupation, etc. At least some implementation described herein enable a patient's address to be automatically linked to external data sources such as Census data and OSM data that can provide additional characteristics such as neighborhood level demographics, socio-economic status, residential density, and so forth. This information can expose highly relevant aggregative segmentations such as ‘living in a poor and dense neighborhood increases the risk of a pandemic eruption’ without revealing the private information of a patient to the analyst.

Another technical problem relates to the data, which may be obtained from a single source, but is still not suitable for human consumption. E.g., internal company emails have a trove of information yet privacy prevents any data scientists, even from within the company, to analyze them. At least some implementation described herein solve this technical problem by automatically producing aggregative insights, such as on the effect of various email patterns on business outcomes without having a human look at a small set of data to attempt to generate aggregations.

At least some implementations described herein improve upon existing approaches. For example, some existing approaches for privacy issues use aggregation in a query based fashion, in which case the data owner has to make sure that these aggregations along with a sequential querying process will not reveal any individual's data. In contrast, at least some implementations described herein map permissions of the datasets to the computed aggregation, to determine whether the aggregation data is presented or hidden.

Another prior approach provides a straightforward way to deal with PIIs by anonymizing the data through dropping or encoding the sensitive information. Although this simple solution is easy to implement, data has the tendency to encode information in different ways so that individuals can still be identified though different metrics. In addition the encoding or dropping of some of the data causes severe loss of data richness and granularity that can be leveraged through external data sources to provide additional insights. In contrast, at least some implementations described herein apply permissions to hide the data while enabling full use of the underlying data.

Yet another prior approach is to use synthetic data, which can also be used as a representative of the patterns. However, it's difficult to find some data that would indeed provide all (or at least a significant amount of) the information held in the real data. In contrast, at least some implementations described herein apply permissions to select the data which is visible and represents the underlying information, for example, the schema of the dataset.

Yet another prior approach to deal with privacy is through differential privacy for access to the data and adding random noise to the data. However, this approach influences the ability to precisely capture the data through features and models. In contrast, at least some implementations described herein apply permissions to determine which data may be presented, and utilize the underlying data to compute features and/or train ML models.

In cases of leveraging external data, it usually comes from a 3rd party that collects the data from the full market but cannot share it in full, for different privacy considerations, therefore only aggregations over the data are being shared. These are usually defaultive predefined summary statistics over the data that might not fully benefit the consumer of the data. That is the features that will be used for modeling later on, are predefined and not necessarily reflect the patterns in the data. In contrast, at least some implementations described herein apply permissions to data presented to the user that links the primary and second dataset(s). Metrics and/or features are computed for the linked data of the underlying datasets, irrespective of the permissions for the primary and secondary dataset(s).

Another prior approach is Federated learning, in which the modeling is done over different datasets without centralized access to each of the datasets. In which case the model structure and definition is decided in advance and does not leave as much room for exploration of different features that would best explain the data. In contrast, at least some implementations described herein perform centralized training using records of linked primary and secondary datasets using features computed for the linked records. Privacy of the datasets is maintained by applying the permissions when the datasets are presented on a display for linking.

At least some implementations described herein address the technical problems described herein using the hypothesis engine described herein, that accesses the different datasets, and automatically matches them, in order to calculate the best aggregations that would adequately describe the patterns in the data. These aggregations can be leveraged, for example, as business insights to drive decision making, and/or for generating training datasets for training ML model(s) for predictions. The entire process may be automated, therefore people who run the platform can be restricted from accessing and viewing the raw data, and by that maintain the permissions and integrity of the full datasets. This generates, for example, an AI empowered machine that extracts human-level ideas from data whilst it keeps sensitive data hidden from human eyes. As a result the machine may create a unique flow of connecting the dots between data from different sources. This data may be processed for generating, for example, creative ideas to improve performance. The machine may autonomously test the ideas on the data and/or may present the ideas in plain English.

At least some implementations described herein leverage automated data science on sensitive data where the user is now allowed to see some or all of the data being analyzed.

At least some implementations described herein allows the user to view and/or explore the dataset without necessarily having access to the raw data. For example, the user is able to get rid of target leaks; to reach conclusions that stem from biased or small data, and many more. Moreover, this analysis may be done without compromising the sensitivity of the raw data. Protecting the data is crucial for a successful application of data science.

An example use case is now described. Consider the coronavirus (COVID-19) crisis where the goal is to predict potential places where the epidemic will erupt. Or in another example, to predict where many high risk patients will appear. The sensitive data to hide includes patients and their addresses along with sickness indicators. The permissions indicate that the data scientists are not allowed to see records of specific patients. Embodiments described herein link personal addresses (e.g., zip codes) to neighborhood demographics, density, and/or other characteristics (e.g., via census or OSM data). An example of an insight feature found using embodiments described herein is that living in a poor or a dense neighborhood increases risk without compromising the sensitivity of specific patients. The user can then make sure that such features do not give rise to target leaks (that often stem from ill data collections), biased data, etc., which helps ensure successful data science processes.

Another use case is now described. Some data is too sensitive to allow even the employees of the company who owns it to view it for the purpose of analytics. For example, internal company e-mails—may be restricted from allowing anyone to read the raw text. However, at the same time, it is desired to be able to aggregate and/or extract insight features from the restricted raw text of the emails. The insight features may be varied, for example, phrases in e-mail, topics discussed by recipients, trends and/or changes, and the like. Before looking at the data it is hard to make a comprehensive list of all the hypothesis to test on the data. Embodiments described herein provide a blind fold analytics solution that uses the hypothesis engine described herein that generates many hypothesis features, and tests the hypothesis features on the sensitive data without the user being able to view the data, generating a diverse set of insight features which have strong diverse correlations with the target variable. These insight features can be used on their own, and/or for predictive modeling. For example, to predict churn risk of an employee using their professional e-mail while not telling the manager or HR exactly why this employee is flagged as high churn risk. General insights about drivers for churn may be obtained without specifying specific employees these facts are relevant to.

Yet another use case is now described, in which different parties hold different datasets with different schema. Two or more organizations (e.g., companies) having secret data may still perform flexible analytics together without the rigidity of federated learning, secure multi party computation, or other complex data security approaches. In at least some embodiments described herein, there is no need to define the computation to be done on the data in advance. For example, a consumer packaged goods (CPG) manufacturer has data on its products and attributes and how much is sold to retailers. The retailers have more granular customer and basket level data. The retailer won't share the data with the manufacturer, which is significant for the manufacturer to understand in aggregate who buys their products with what, when, where etc. The insights themselves are useful, allowing, for example, optimization of supply chain, distribution, manufacturing scheduling, and the like. It is noted that the same schema may be found in different branches of the same retailer, which may be used.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

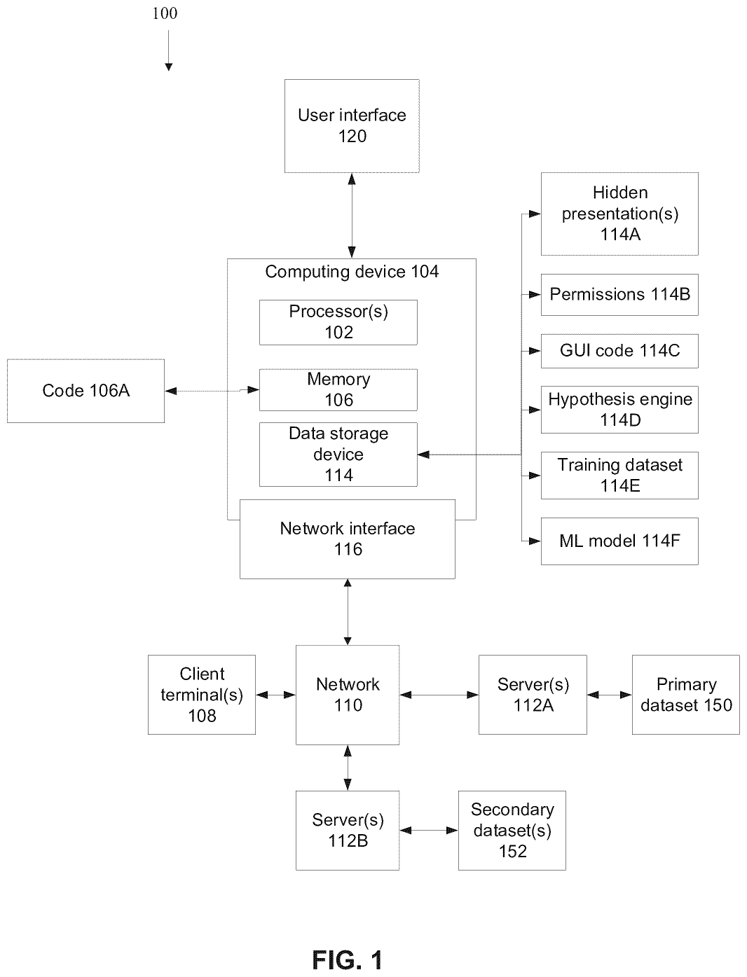

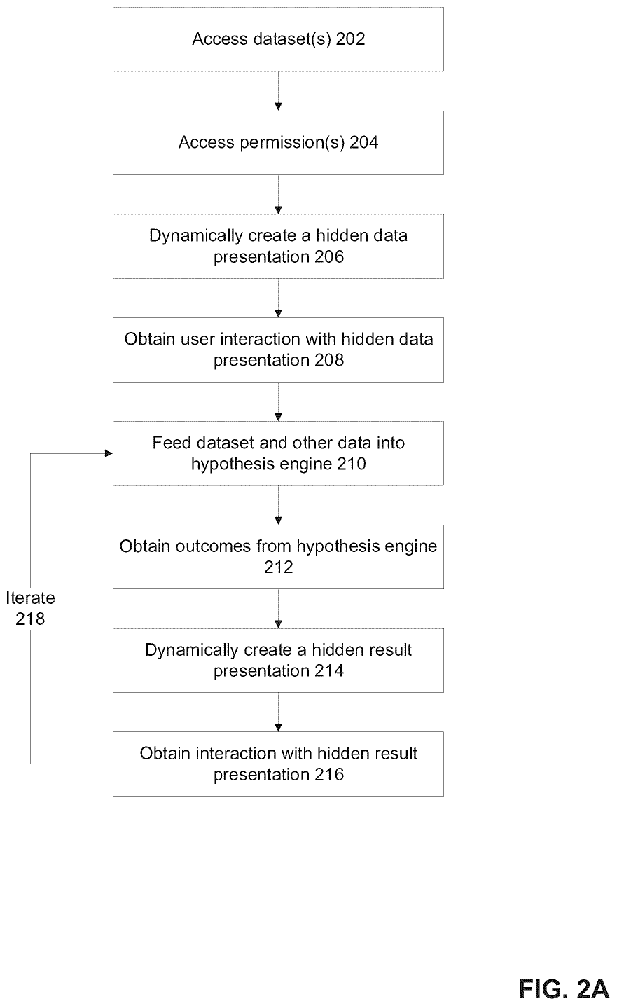

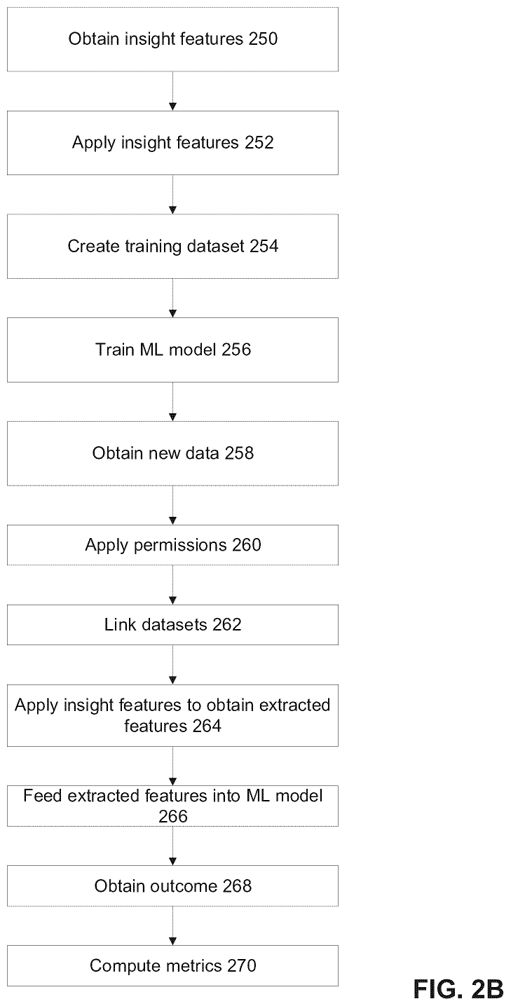

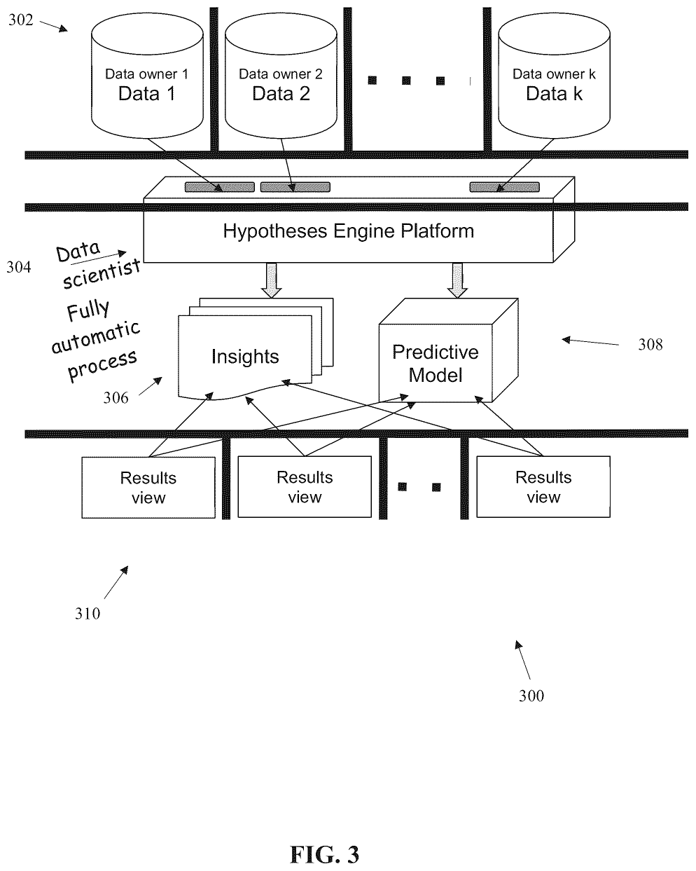

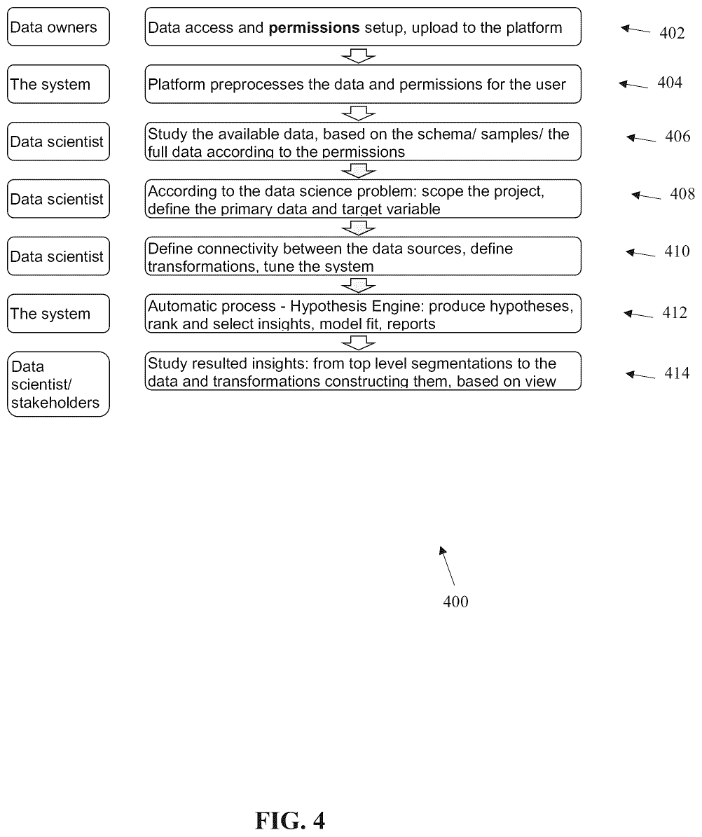

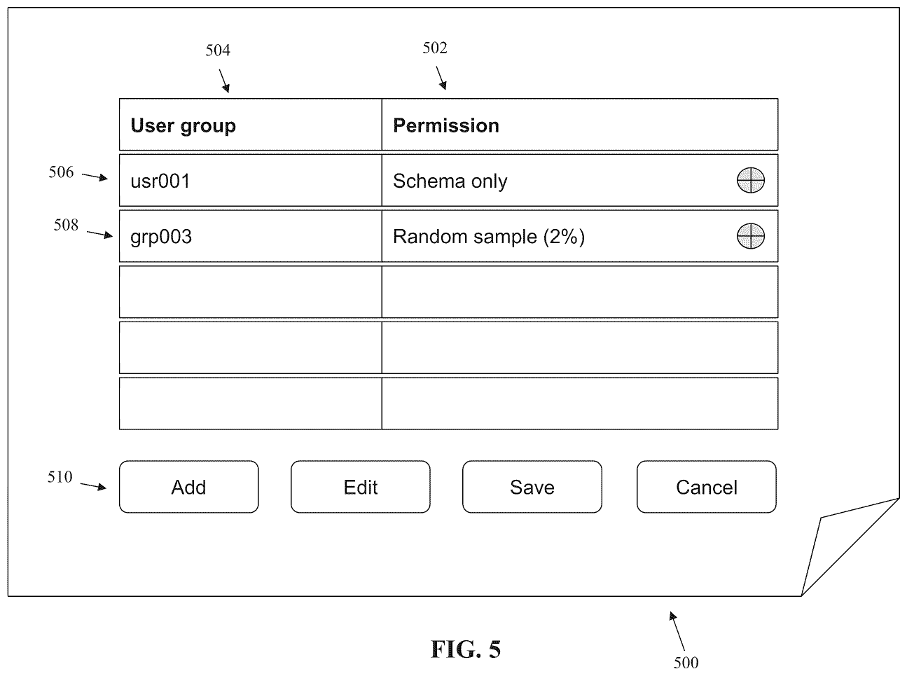

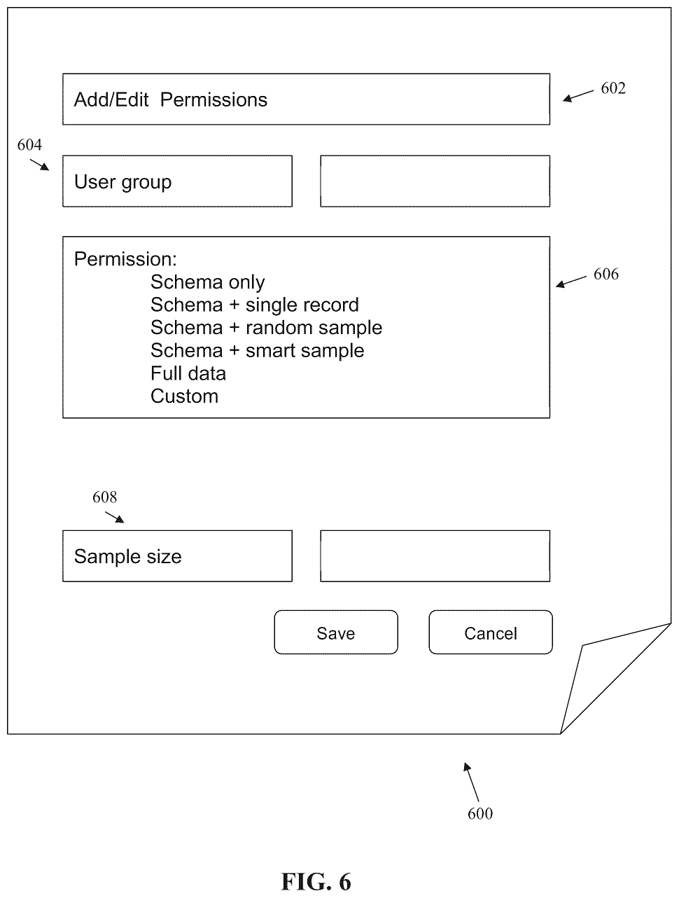

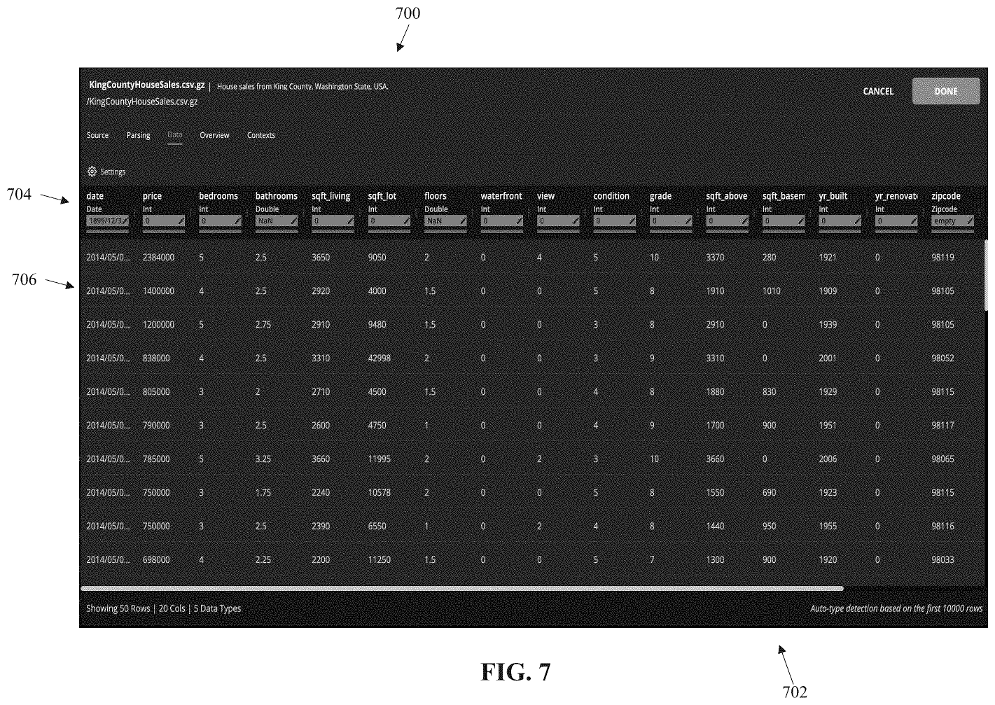

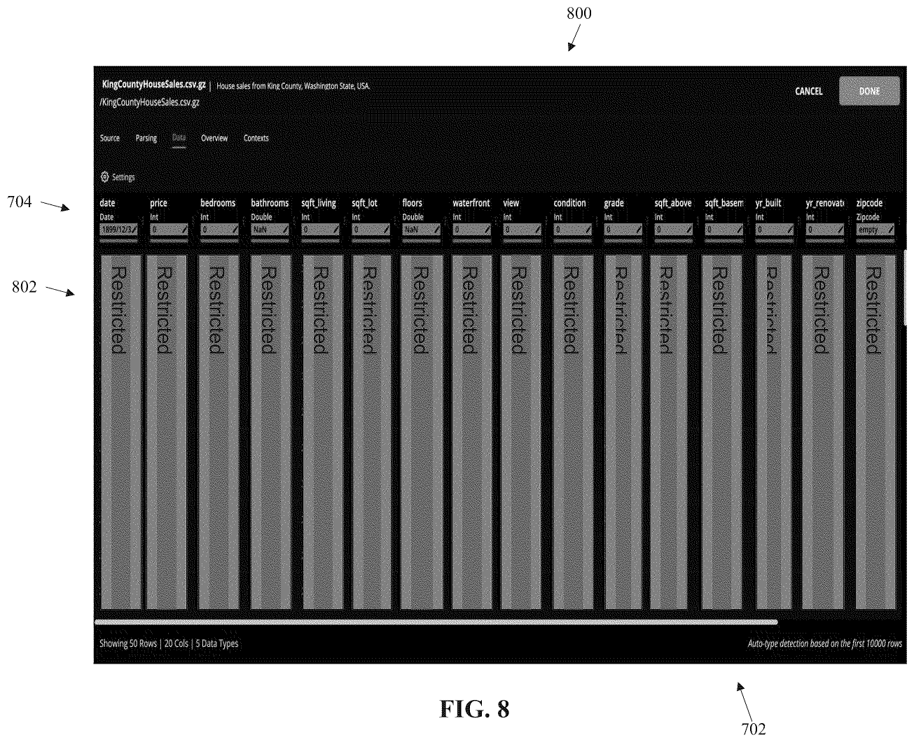

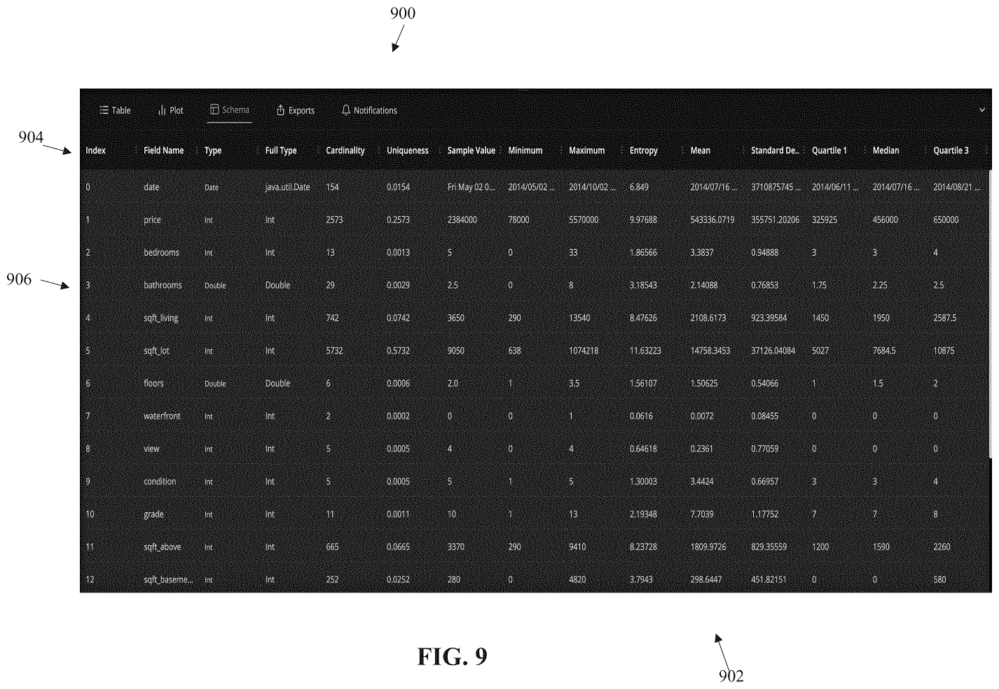

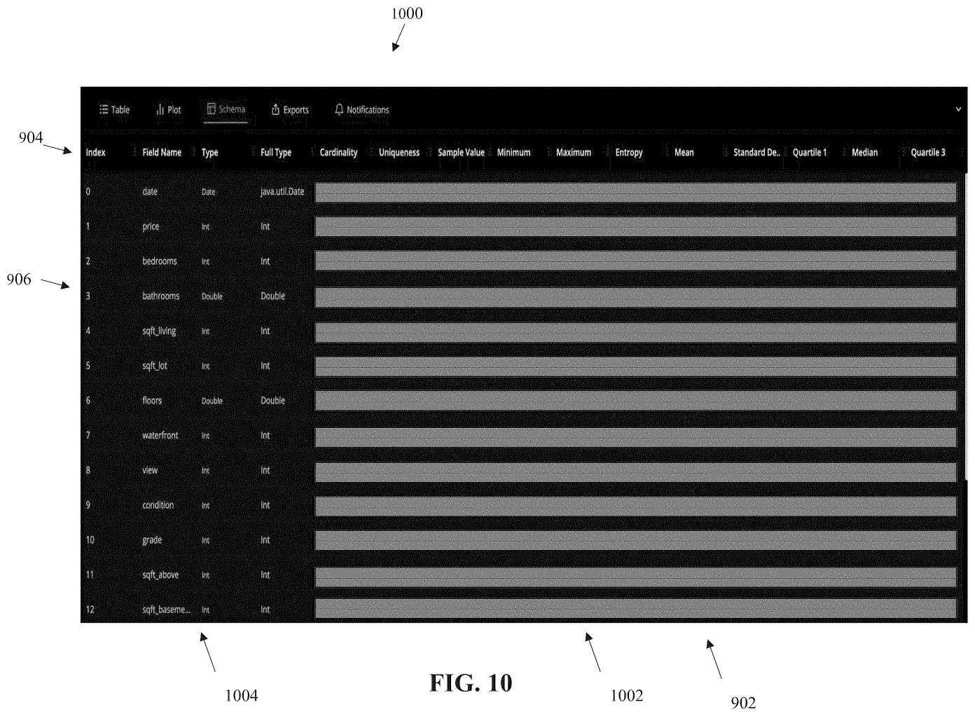

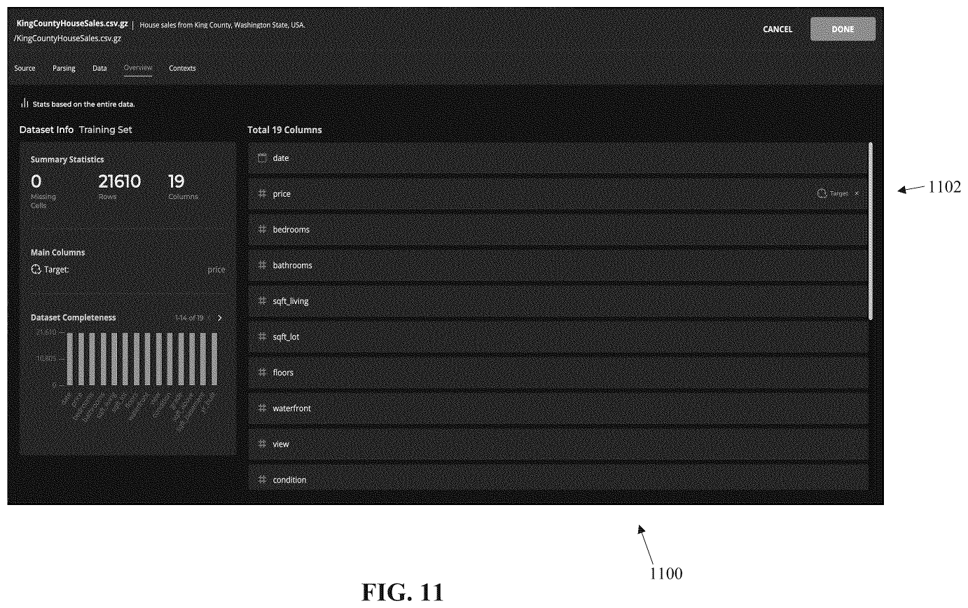

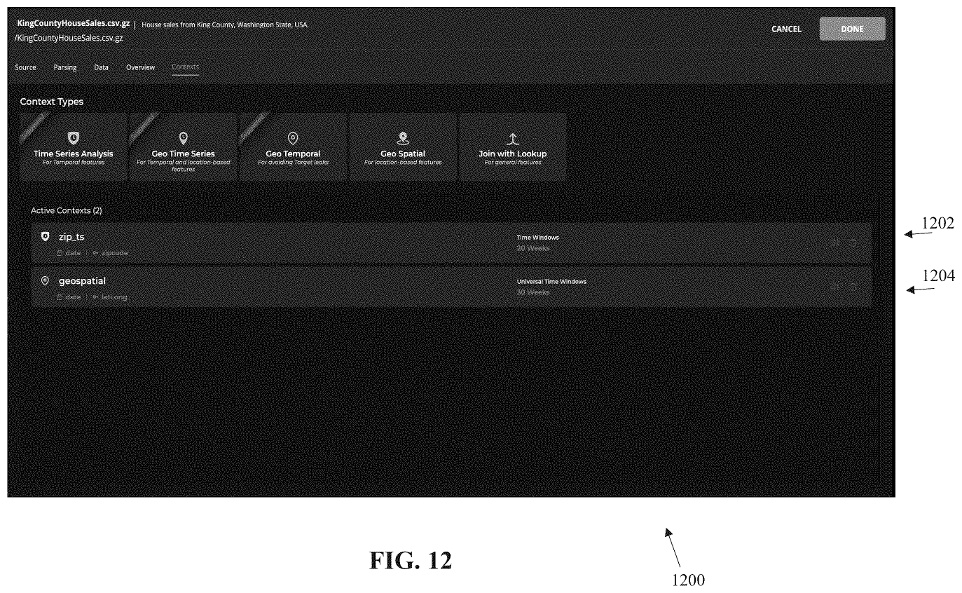

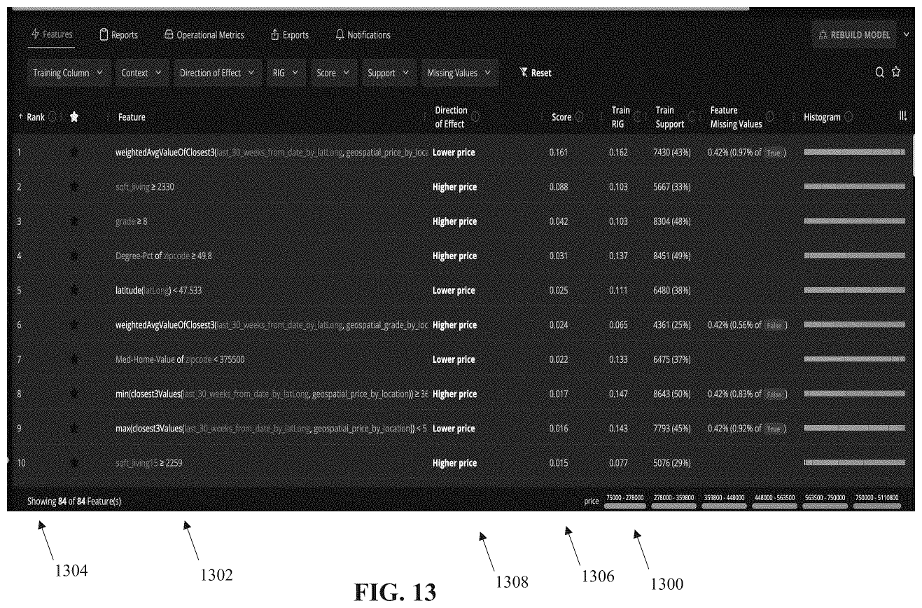

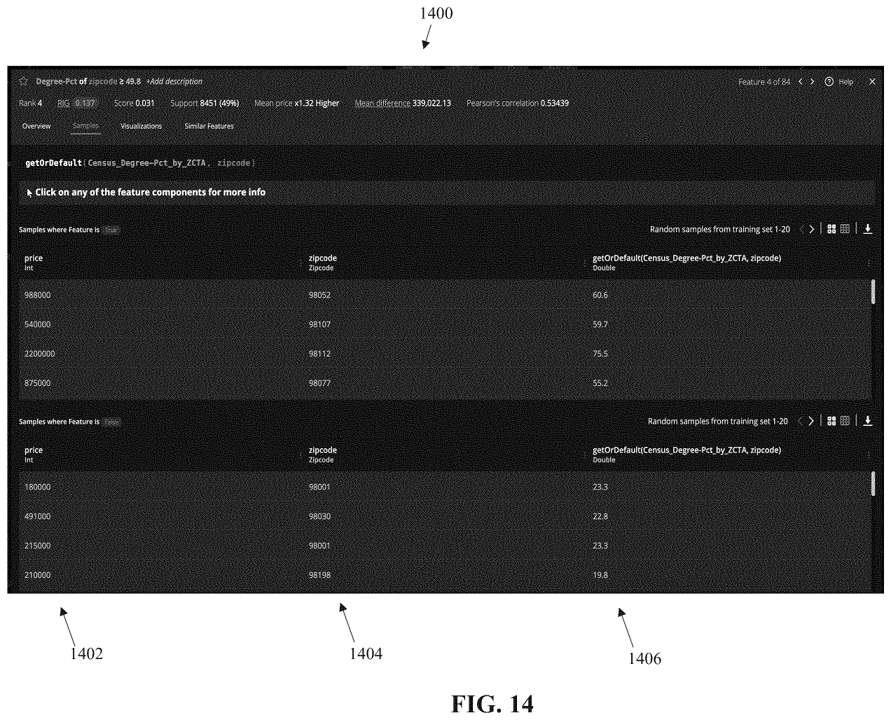

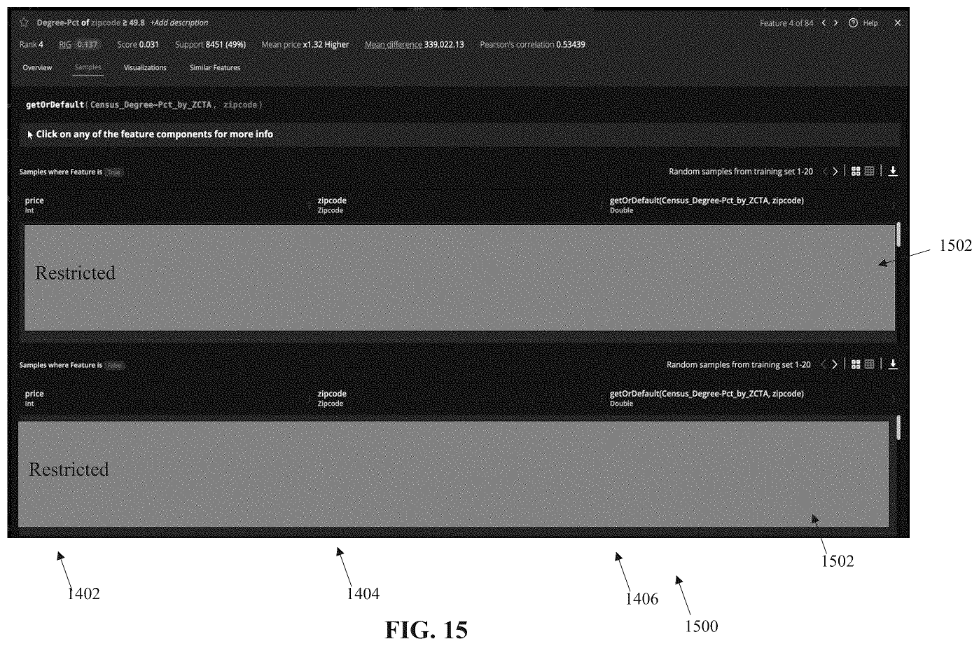

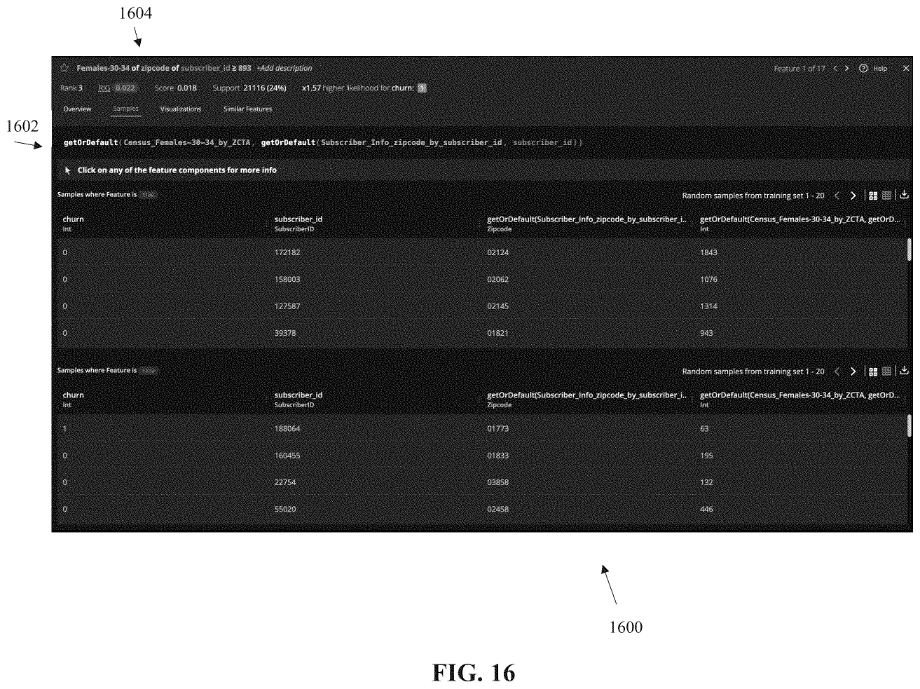

Reference is now made to FIG. 1, which is a block diagram of components of a system 100 for dynamic creation of a hidden data presentation and/or hidden result presentation, in accordance with some embodiments of the present invention. Reference is also made to FIG. 2A, which is a flowchart of a method of dynamic creation of a hidden data presentation and/or hidden result presentation, in accordance with some embodiments of the present invention. Reference is also made to FIG. 2B, which is an exemplary method for training a machine learning model and/or inference by the machine learning model (also referred to herein as a predictive model) using the insight features, in accordance with some embodiments of the present invention. Reference is also made to FIG. 3, which is a dataflow diagram 300 depicting exemplary dataflow for generating insight features from sensitive data hidden in a presentation to a user, in accordance with some embodiments of the present invention. Reference is also made to FIG. 4, which is another dataflow diagram 400 depicting exemplary dataflow for generating insight features from sensitive data hidden in a presentation to a user, in accordance with some embodiments of the present invention. Reference is also made to FIG. 5, which is a schematic of an exemplary GUI 500 for defining permissions 502 for different users (e.g., groups of users) 504, in accordance with some embodiments of the present invention. Reference is also made to FIG. 6, which is a schematic of an exemplary GUI 600 for defining permissions 602 for a user (e.g., user) 604, in accordance with some embodiments of the present invention. Reference is also made to FIG. 7, which is a schematic of an exemplary GUI 700 presenting data of a dataset without applied permissions, in accordance with some embodiments of the present invention. Reference is also made to FIG. 8, which is a schematic of an exemplary GUI 800 presenting data of a dataset to which permissions are applied, in accordance with some embodiments of the present invention. Reference is also made to FIG. 9, which is a schematic of another exemplary GUI 900 presenting data of a dataset without applied permissions, in accordance with some embodiments of the present invention. Reference is also made to FIG. 10, which is a schematic of an exemplary GUI 1000 presenting data of a dataset to which permissions are applied, in accordance with some embodiments of the present invention. Reference is also made to FIG. 11, which is a schematic of an exemplary GUI 1100 presenting data of a dataset to which permissions are applied, for designation of a target variable 1102 by a user, in accordance with some embodiments of the present invention. Reference is also made to FIG. 12, which is a schematic of an exemplary GUI 1200 presenting data of a dataset to which permissions are applied, for linking by a user to one or more other datasets, in accordance with some embodiments of the present invention. Reference is also made to FIG. 13, which is a schematic of an exemplary GUI 1300 presenting insight features 1302 generated by the hypothesis engine, in accordance with some embodiments of the present invention. Reference is also made to FIG. 14, which is a schematic of an exemplary GUI 1400 presenting additional details of a selected insight feature generated by the hypothesis engine without applying restrictions, in accordance with some embodiments of the present invention. Reference is also made to FIG. 15, which is a schematic of an exemplary GUI 1500 presenting additional details of a selected insight feature generated by the hypothesis engine to which restrictions are applied, in accordance with some embodiments of the present invention. Reference is also made to FIG. 16, which is a schematic of another exemplary GUI 1600 presenting additional details of a selected insight feature generated by the hypothesis engine without applying restrictions, in accordance with some embodiments of the present invention.

System 100 may implement the acts of the method described with reference to FIGS. 2A-16 by processor(s) 102 of a computing device 104 executing code instructions stored in a memory 106 (also referred to as a program store).

Computing device 104 may be implemented as, for example one or more and/or combination of: a group of connected devices, a client terminal, a server, a virtual server, a computing cloud, a virtual machine, a desktop computer, a thin client, a network node, and/or a mobile device (e.g., a Smartphone, a Tablet computer, a laptop computer, a wearable computer, glasses computer, and a watch computer).

Multiple architectures of system 100 based on computing device 104 may be implemented. For example:
A centralized architecture. Computing device 104 executing stored code instructions 106A, may be implemented as one or more servers (e.g., network server, web server, a computing cloud, a virtual server) that provides centralized services (e.g., one or more of the acts described with reference to FIGS. 2A-16) to one or more client terminals 108 over a network 110. For example, providing software as a service (SaaS) to the client terminal(s) 108, providing software services accessible using a software interface (e.g., application programming interface (API), software development kit (SDK)), providing an application for local download to the client terminal(s) 108 such as GUI code 114C, providing an add-on to a web browser running on client terminal(s) 108, and/or providing functions using a remote access session to the client terminals 108, such as through a web browser executed by client terminal 108 accessing a web site hosted by computing device 104 such as remote access of GUI code 114C. For example, client terminal(s) 108 access GUI code 114C running on computing device 104 over network 110 to select the target variable and/or to define links between a primary dataset 150 and secondary dataset(s) 152. Computing device 104 computes features and/or generates training dataset 114E and/or trained ML model 114F, as described herein. The identified features and/or generated training dataset 114E and/or trained ML model 114F may be provided back to the client terminal 108 that provided the input for selection of the target variable and/or to link the primary and second datasets.
A local architecture. Computing device 104 executing stored code instructions 106A that implement one or more of the acts described with reference to FIGS. 2A-16 may be implemented as a standalone device, for example, a web server hosting one or more web sites, an administrative workstation, a client terminal, or a smartphone. Computing device 104 may locally executed GUI code 114C to select the target variable and/or define links between a primary dataset 150 and secondary dataset(s) 152. Computing device 104 may locally compute features and/or generate training dataset 114E and/or trained ML model 114F, as described herein.
A combined local-central architecture. Computing device 104 may be implemented as a server that include locally stored code instructions 106A that implement one or more of the acts described with reference to FIGS. 2A-16, while other acts described with reference to FIGS. 2A-16 are handled by client terminal(s) 108. For example, computing device 104 generates training dataset 114E from links between the primary and secondary datasets, and client terminal 108 trains ML model 114F using training dataset 114E, as described herein.

Primary dataset 150 and/or secondary dataset(s) 152 may be located, for example, on a data storage device 114 of computing device 104, on server(s) 112A, on server(s) 112B, or combination thereof, for example, both datasets are located on the same data storage device, or different datasets are located on different storage devices.

Hardware processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2A-16 when executed by hardware processor(s) 102.

Computing device 104 may include a data storage device 114 for storing data, for example, hidden presentation(s) 114A (i.e., the hidden data presentation and/or hidden result presentations) that hides presented data according to permissions, permissions 114B that define what data to hide during presentation, GUI code 114C that provide a GUI for presenting the hidden presentations and/or interacting with the hidden presentations, hypothesis engine 114D that computes the insight features, training dataset 114E that generates training data using the hidden features, and/or ML model 114F that is trained on the training dataset, as described herein. Data storage device 114 may be implemented as, for example, a memory, a local hard-drive, virtual storage, a removable storage unit, an optical disk, a storage device, and/or as a remote server and/or computing cloud (e.g., accessed using a network connection). It is noted that code stored on data storage device 114 is loaded into memory 106 for execution by processor(s) 102.

The hypothesis engine 114D is code that when executed automatically generates hypotheses from data. Hypothesis engine 114D produces a set of insight features that are highly correlated with the target variable, by testing multiple hypothesis features on the data and selecting a subset of hypotheses with relevant correlations, diversity, and other optional applied requirements. Additional details of hypothesis engine 114D are described herein.

Network 110 may be implemented as, for example, the internet, a local area network, a virtual network, a wireless network, a cellular network, a local bus, a point to point link (e.g., wired), and/or combinations of the aforementioned.

Computing device 104 may include a network interface 116 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 may be in communication with one or servers 112A-B which may host primary dataset 150 and/or secondary dataset(s) 152 and/or client terminal(s) 108 via network 110.

Computing device 104 includes and/or is in communication with one or more physical user interfaces 120 that include a mechanism for a user to enter data (e.g., select target variable, generate links between the primary and secondary datasets) and/or view data (e.g., view the data with applied permissions). Exemplary user interfaces 120 include, for example, one or more of, a touchscreen, a display, a virtual reality display (e.g., headset), gesture activation devices, a keyboard, a mouse, and voice activated software using speakers and microphone.

Referring now back to FIG. 2A, at 202, the processor of the computing device accesses one or more datasets. Optionally, a primary dataset, and two or more secondary datasets are accessed. Alternatively, a single dataset is accessed.

As used herein, the term data entity may be interchanged with the term dataset and/or data source.

The datasets may be provided, for example, uploaded to the computing device, and/or the datasets may be hosted by one or more terminals (e.g., servers) with granted access to the computing device, blog storage access, and the like.

The datasets may be implemented as, for example, databases, tables (i.e., tabular dataset) that includes rows and columns, geospatial map with attributes, other data sources, and the like.

At 204, the processor accesses one or more permissions, also referred to herein as data permissions. The permissions define viewing of data of the dataset(s) themselves (e.g., sensitive data), and/or define viewing of the data used for computation of the insight features, as described herein.

The sensitive data of the dataset is defined by the permissions (e.g., by the owner of the dataset), which restrict viewing and/or sharing of the sensitive data in full. As there are different reasons to mark a data as sensitive, different levels of permissions for accessing and/or viewing the data may be defined, optionally for different users.

The permissions may be defined for each dataset, for example, different permissions for different datasets.

When the dataset is implemented as a table that includes columns of data, the permissions may be defined for the table as a whole, or per column.

The permissions may be defined, for example, globally for all users, per user credential, and/or per user group. The permissions may be predefined (e.g., accessed from storage) and/or dynamically defined (e.g., defined in response to access to the dataset(s)). The permissions may be defined differently by the data owner of each dataset. The permissions may be defined via a GUI, for example, as described herein.

Permissions may include full data restrictions in which column headers (or other structure) are presented while hiding all of the actual data. Alternatively, permissions may include partial data restriction in which some data of some columns is presented while hiding the actual data of the other columns.

Exemplary permissions, which may be applied to different datasets, include: hiding all data of the dataset except for the data schema, partially hiding data of the dataset and allowing viewing of the other data (e.g., a sample of the data), no hiding of any data of the dataset.

For tabular data, the schema may include a list of column names and their data types. Optionally, a nested data structure is defined with nested keys and optionally the types. A tabular data schema may include as little as the variable/field name and type, or as much as summaries and/or quantifiable summaries over the dataset, and/or an example of a sampled value.

When permissions are undefined and/or unset, a default permission may be defined, for example, a schema only (i.e., structure) view permission that enables viewing the headers of the columns, and hides the actual data, such as hides the rows and/or records.

A user may have full access to some of the data, and be restricted from viewing other parts of the data, for example, on a per column basis. In another example, the user may be allowed to see some rows and be restricted to see other rows, for example, a sample of rows of data may be selected (e.g., randomly, predefined, by rank) for viewing while hiding other rows of data.

Users may be restricted from downloading the hidden data that permissions prohibit them from viewing. This prevents users from sharing sensitive data.

As used herein, the term data owner refers to an entity such as a person and/or organization, that owns the intellectual property of the dataset, and is able to grant access to the dataset and/or defined permissions for viewing the dataset.

At 206, the processor dynamically creates a hidden data presentation by applying the permissions to one or more datasets. Data of records are hidden when the hidden presentation is presented. The schema is visible to the user. The data of selected columns, or data of all columns, may be hidden. The data may be hidden, for example, by an overlay of a solid shape over the data, blurring of the data, removal of the data, and the like.

In the case of multiple datasets, the processor may dynamically create one or more secondary hidden data presentations by applying secondary permissions to the secondary dataset(s). Each dataset may have its own set of permissions, and/or a set of permissions may be applied to multiple datasets. The secondary hidden data presentation(s) hide data of secondary records.

The hidden presentation(s) are presented on a display, optionally within a GUI.

At 208, a user may interact with the hidden data presentation, optionally via the GUI. The interaction may be, for example, based on a problem that the user is investigating. The user may perform one or more of the following: scoping of the dataset(s), view the dataset(s) to help understand the problem, select relevant machine learning models for training on the insight features which are automatically found, and/or select relevant evaluation metrics.

Optionally, the user designates a primary dataset, and one or more secondary datasets. In the case of a single dataset, the single dataset may automatically be designated as the primary dataset. The primary dataset may be implemented as, for example, a tabular dataset that has at least two columns. The primary and secondary dataset designations may be used, for example, for linking secondary dataset(s) to the primary dataset. It is noted that the primary and secondary designations may be performed, for example, prior to creation of the hidden presentation(s), and/or using the hidden presentation(s). For example, two datasets are presented by applying permissions. The user may view the datasets with hidden data, such as viewing the schemas, and designate the primary and secondary datasets.

Links between variables of the primary dataset and variables of one or more secondary datasets may be obtained, optionally from the user via the GUI. The linked variables define a dynamic dataset. The user may join multiple different auxiliary datasets from different data sources and/or from different entities, while hiding the sensitive data and not exposing data of one entity to another entity, and/or to the user. The user may select a column of the same or similar heading, of a same data type, and/or that has same values, to link the two datasets, also referred to herein as key. For example, a dataset of housing sales has an address column, and another dataset of demographic data has an address column. The two address columns, which contain overlapping addresses, are linked, thereby linking the housing sales dataset with the demographic data dataset. Alternatively or additionally, the links for connecting the datasets are generated automatically, for example, by the hypothesis engine. The dataset may be joined, for example, using a key (e.g. as a lookup table), sliced from a secondary dataset based on a time window relative to the first or main dataset, fuzzy join, geospatial nearest join, geospatial all within distance join, a combination of the aforementioned, and the like. For example, the dataset may be external (e.g., public) datasets, such as holidays, weather, and the like. The processor may join on key (a lookup table), take a slice from secondary data based on a time window relative to the first, fuzzy join, geospatial nearest join, geospatial all within distance join, or a combination of the aforementioned. For example if the primary data has an identifier attribute and a date attribute the processor may treat a secondary (potentially sensitive source) as time series data, take the last month of a data before the data for the matching identifier and look at the standard deviation of the data: An exemplary pseudo code is now provided:
timeWindowSlice(primary.key, primary.date, 6 months, Secondary.value).stdev

If the result of such a computation on the data is a complex type that can't be directly used in an ML model and/or measure correlation with, the processor may transform the complex type to a usable feature.

The user may select a target variable, optionally via the GUI presenting the hidden data presentation. The target variable is an attribute in the dataset that the user wishes to explain and/or predict. The target variable is selected from the primary dataset when there are one or more secondary datasets. The target variable may be implemented as, for example, a column. The other non-target variable columns may include data, such as an explanatory variable, or data that can be used to connect to secondary data sources, such as a key to connect to a lookup table, a date, a geospatial location, and the like. A certain column may be used as a key to link to another dataset and/or as data.

As described herein, one or more explanatory variables may be found by the processor (e.g., engine executed by the processor) in response to the selection of the target variable. The explanatory variable(s) may be an attribute used to explain the changes in the target variable. The explanatory variable(s) may found in the primary dataset and/or secondary dataset(s). The explanatory variable(s) may be computed via transformations and/or construction with additional datasets, for example, a function applied to one or more columns, and/or computed from non tabular data such as maps, graphs, and images.

Optionally, one or more transformations applied to one or more variables of the dataset are obtained from the user via the GUI. Examples of transformations include applications of one or more functions, cleaning of the data, transformation to a target format, aggregation of data, and the like. The transformation(s) may be applied to the dataset, prior to feeding of the dataset to the hypothesis engine, to obtain a transformed dataset. The transformation that is applied may be presented within the GUI. The permissions may be applied to the transformed data, with visible and hidden parts of the transformed data defined by propagating the permissions. The transformed dataset is fed into the hypothesis engine (as described herein) for extracting features from the transformed dataset.

At 210, the dataset, optionally the transformed dataset, and the target variable, are fed into the hypothesis engine. The hypothesis engine extracts hypothesis features from the dataset, tests correlations between the hypothesis features and the target variable, and selects a set of insight features according to the correlations.

The dataset fed into the hypothesis engine includes data that is hidden during presentation of the hidden data presentation in the GUI. The hidden data is fed into the hypothesis engine while restricting access of the user to the data, i.e., the user cannot view the hidden data and/or cannot share the hidden data.

Secondary datasets are fed with the primary dataset and the target variable into the hypothesis engine. The hypothesis engine may dynamically link the primary and secondary datasets to create the dynamic dataset, as described herein. Alternatively or additionally, the dynamic dataset created by user provided links between the primary dataset and one or more secondary datasets, is fed into the hypothesis engine. The hypothesis engine extracts hypothesis features from the dynamic dataset.

The hypothesis engine extracts hypothesis features by applying different combinations of functions to the datasets, and selects the set of insight features having a correlation above a threshold and/or having highest ranked correlations. The hypothesis feature may generate the hypothesis features using the explanatory variables in the primary dataset, and the additional datasets that were connected to the system through various definitions described herein. The hypothesis engine may apply one or more transformations and/or computational manipulations over the data, to expose the correlations with the target variable.

The process of data processing and insight feature generation may be referred to as automatic feature engineering.

Exemplary approaches for computing hypothesis functions using automated feature engineering are described, for example, with reference to U.S. Pat. No. 9,324,041, assigned to the same assignee as the present application, and having at least one common inventor. An exemplary hypothesis engine is described, for example, with reference to U.S. Pat. No. 10,410,138, assigned to the same assignee as the present application, and having at least one common inventor. An exemplary approach for linking primary and secondary datasets, and/or an exemplary hypothesis engine is described, for example, with reference to U.S. Pat. No. 10,977,581, assigned to the same assignee as the present application, and having at least one common inventor.

According to the data science problem at hand, the presentation of hidden data, and/or the available data (which is not necessarily presented, and may be hidden), the user (e.g., data scientist) may use the hypothesis engine, via the GUI, to set up the input for the automatic process.

The hypothesis engine is an automated process. The hypothesis engine is fed the input data sources and may connect them with the primary dataset using the various definitions that were provided by the user, and/or may be fed the input data sources connected by the user and/or automatically detected by the engine. The hypothesis engine may apply a variety of transformation and/or computational manipulations over the data, to compute correlations with the target variable. Effectively, the hypothesis engine processes data and turns them into a set of hypothesis features. The engine tests the hypothesis features on the data to produce a diverse set of correlated insights features.

The hypothesis engine may explore the space of possible joins and/or transformations looking for correlations. The hypothesis engine may filter the potential features using one or more statistical metrics and/or select a diverse set of features/insights which correlate with the target variable. Optionally heuristic search methods may be used to evaluate a small portion of the combinatorial space of potential features.

One or more computations may be applied to the data, in order to transform the data to be correlated with the target variable. For example, when the primary data has an identifier attribute and a date attribute, a secondary (potentially sensitive source) may be treated as time series data, take the last month of a data before the data for the matching identifier and look at the standard deviation of the data. Exemplary pseudo code may be as follows:
timeWindowSlice(primary.key, primary.date, 6 months, Secondary.value).stdev

In cases in which the result of such computation on the data is a complex type which can't be directly used in a machine learning model and/or can't be used to measure correlation, the complex type may be transformed to a usable feature, for example, using existing approaches.

The hypothesis engine may compute and/or explore the space of possible joins and/or transformations looking for correlations. The hypothesis engine may filter candidate features using one or more statistical metrics (e.g., exclude candidate features below a threshold correlation with the target value). The hypothesis engine may select a set of insight features which correlate with the target variable, for example, highest ranked and/or above the threshold. Optionally, the hypothesis engine uses heuristic search methods to evaluate a small portion of the combinatorial space of potential features.

At 212, the processor obtains outcomes from the hypothesis engine, for example, insight features, modeling, predictions, and/or reports.

An exemplary output of the hypothesis engines is a subset of insight features. The insight features may be converted to a format designed to be interpretable by a human. The insight features are statistically correlated with the target variable, without revealing the content of individual records as defined by the permissions.

One of the outputs of this process is a subset of features that are both human interpretable, and statistically correlated with the target variable at hand, yet they do not reveal the content of individual records.

At 214, the processor dynamically creates a hidden result presentation by propagating the permissions to the portions of the dataset used to compute the insight features.

The insight features may be human interpretable, such that they not reveal the content of individual records, and are statistically correlated with the target variable at hand.

The user may view a set of insight features that indicate as to how the various explaining variables correlate with the predefined target variable.

The permissions may be applied to one or more explanatory variables of the dataset that are used for computing insight features. The explanatory variables may be hidden in the hidden result presentation according to the permissions.

At 216, the processor presents the hidden result presentation within the GUI. The hidden result presentation presents the insight features and hides the portions of the dataset used to compute the insight features according to the permissions. The permissions are applied to the explanatory variables used to compute the insight features. The user may view the insight features, and view the schema used to compute the insight features, without the ability to view the data used to compute the insight features according to the permissions.

Optionally, the processor converts an insight feature from a mathematical representation of computation of the insight feature, to a human readable text format. The GUI may present the human readable text format in the hidden result presentation.

Variables of the dataset to which permissions are applied are propagated to underlying data for computing the insight feature. The underlying data is hidden during presentation of the hidden result presentation in the GUI.

Optionally, the GUI presents without hiding, insight features which are computed by aggregating data from a subset of the records to which permissions are applied. Since the underlying data cannot be determined from the aggregation result, the aggregated result may be presented within the GUI.

Values of the insight features computed from the dataset may be hidden by propagating the permissions from the values of the dataset used to compute the values of the insight features to the values of the insight features.

The GUI may enable a selection of an insight feature computed from a portion of the dataset hidden according to the permissions. In response to the selection, the GUI presents computed correlations between the selected insight feature and the target variable.

The insight features presented in the hidden result presentation may include explanatory variables that explain changes in the target variable, while hiding values of the explanatory variable and hiding computations performed based on the explanatory variable.

The GUI may be used for viewing the insight features in multiple different levels, for example, starting at a human interpretable insight, to the granular data that construct the insight.

For each insight feature, the GUI may be used to study the nature of the insight feature. For example, the construction of the insight feature, such as the approaches used to connect and/or manipulate the various data sources.

The GUI may be used for exploring different statistical metrics that may be computed. These metrics may help in evaluating the insight feature, and/or correlation of the insight feature with the target variable.

The GUI may provide different options available for exploring different insight features. For example, for insights based on non-sensitive data to which no permissions are applied, the GUI may present sample records and show data enriched with the insight feature. For insight features that are based on sensitive data to which permissions are applied, the GUI may show a limited set of metrics that maintains the integrity of the data. The permissions for the insight features are automatically derived from the data sources' permissions. As a single insight feature may rely on more than one data source, the most restrictive permissions is applied to that insight feature.

At 218, the processor may iterate one or more features described with reference to 210-216, optionally in response to user input received via the GUI. The user input obtained via the GUI may be for different links between the datasets, and/or different transformations applied to the data. Different adapted insight features may be found in the iterations in response to the user input.

Referring now back to FIG. 2B, at 250, the processor obtains insight features, as described with reference to FIG. 2A. The GUI may be used for selecting the insight features, and/or excluding insight features.

At 252, the processor applies the insight features to the records of the dataset(s) to obtain sets of extracted features. The insight features are applied to the full data of the dataset, even when permissions are applied to the data. The insight features may be presented, while the actual data is hidden. The permissions may be propagated to the extracted features.

At 254, the processor creates a multi-record training dataset. A training record includes a set of extracted features of a dataset record and a ground truth indicated by a value of the target variable of the record.

At 256, the processor trains a machine learning model on the training dataset.

The ML model may be implemented using one or more architectures, for example, a binary classifier, a multi-class classifier, a detector, one or more neural networks of various architectures (e.g., convolutional, fully connected, deep, encoder-decoder, recurrent, graph, combination of multiple architectures), support vector machines (SVM), logistic regression, k-nearest neighbor, decision trees, boosting, random forest, a regressor and the like.

At 258, new data is obtained. The new data complies with the schema of the dataset(s) used to obtain the insight features and/or used to create the training dataset.

Optionally, a new primary dataset having a schema of the primary dataset is obtained, and/or a new secondary dataset(s) having a schema of the secondary dataset is obtained.

At 260, the processor applies permissions to the new primary dataset and the new secondary dataset(s) for hiding data during presentation.

At 262, the new primary dataset is linked with the secondary dataset(s) for creating a new dynamic dataset. The linking may be done manually by the user via the GUI and/or automatically by the processor using the linking performed for the training datasets used to train the ML model.

When the datasets are from different parties, the different datasets may be linked without exposing data of either party to each other, according to the permissions.

At 264, the processor applies the insight features to the new dynamic dataset to obtain extracted features.

At 266, the processor feeds the extracted features into the machine learning model.

At 268, a result value of the target variable is obtained as an outcome of the machine earning model.

The values of the target variable (also referred to as predictions) are obtained without exposing the underlying computation of the features used by the model. Integrity of the sensitive data that remains hidden from the user is maintained. The GUI may be used to apply the ML model on data and for presenting prediction results without being able to see some of the data and some of the intermediate feature calculations.

It is noted that predictions may be masked with a small random noise to prevent reverse engineering and/or the exposure of the sensitive data. This is because a predictive model scheme may be treated as a querying system on the training data. An adversarial user may try and leverage that to expose the sensitive data. The ML model may mask the predictions with randomized noise to prevent such attacks and/or reverse engineering of the results that may expose the sensitive data.

At 270, one or more metrics of the ML model are computed.

The GUI may present metrics that measure the importance of the insight features for the model's predictions, for example, Shapley and/or SHAP values.

The metrics may be used for continuous evaluation of the set of insights and model performance over time.

Referring now back to FIG. 3, at 302, one or more datasets are made available, for example, uploaded and/or granted access by one or more data owners. Each dataset may be associated with a permission set. Each data owner may designate their data as being available for analysis, along with a list of access permissions for that data. The minimum permission allows viewing the data schema.

The datasets are made available for presentation on a display within a GUI by applying the permissions. The data of the datasets is made available to the hypothesis engine, unrestricted by the permissions.

At 304, based on the permissions applied to dataset(s), a hidden presentation is created for presentation within a GUI. The hidden presentation exposes the user to as much as the schema of the data of the dataset(s) as defined by the permissions.

The user (e.g., data scientist) may link the datasets and/or data sources together via the GUI. An automated process may be triggered. The linked data is fed into the hypothesis engine. The hypothesis engine may be fed an indication (e.g., pointer to the physical location of the file) to the primary dataset as well as any additional secondary datasets, data sources and/or resources that are relevant to the problem, including the links and/or transformations defined by the user via the GUI. The hypothesis engine may connect the datasets and/or define the relationship between the different data entities, processing them, and/or preparing for the next stage.

At 306, based on the fed data the hypothesis engine generates hypotheses, tests the hypotheses and/or prioritizes the hypotheses to converge to a limited set of data driven insight features.

At 308, the insight features may be used to train a machine learning model, for example, a predictive model.

At 310, the GUI presents the results to the user (e.g., data scientist) based on the predefined data permissions that were originally granted, for example, by the data owner. The data scientist may see as much as the insight itself, or in higher permission levels also data samples of that feature and the transformations on the input data that led to the final feature.

Referring now back to FIG. 4, at 402, the data owners (or another entity) may provide data access and/or setup permissions for dataset(s). The dataset(a) and/or permissions are made available to the processor and/or uploaded to the computing device.

At 404, the platform may preprocess the dataset(s) and the permissions. The processor generates a hidden presentation by applying the permissions to the dataset(s).

At 406, the hidden presentation is presented in the GUI. The user, for example a user (e.g., data scientist), may study the available data, based on the schema and/or samples that hide sensitive data according to the permissions.

At 408, the data scientist may perform the following according to the data science problem: scope the project, define the primary data and/or define the target variable.

At 410, the GUI is used by the user to define connectivity between the data sources, define transformations, and/or tune the generation of insight features by the hypothesis engine.

At 412, the hypothesis engine automatically generates hypotheses, ranks the hypotheses, and selects insight features. The insight features may be presented within the GUI, and/or used to train a machine learning model.

At 414, the user may study the generated insight features presented within the GUI, for example, from top level segmentations to the data and/or transformations constructing them, based on propagation of the permissions.

Referring now back to FIG. 5, GUI 500 is designed for a user to define different permissions 502 for different users 504, such as groups of users. For example, entry 506 indicates that for the user “usr001”, only the schema is to be presented, and the actual data is hidden. Entry 508 indicates that for the user “grp003”, a random sample of 2% of the data is to be presented, while the other 98% of the data is hidden. Icons 510, such as “Add” to add another user group and permission, “Edit” to edit existing users and permissions, “Save” to save the defined permissions, and “Cancel” to cancel the permissions, may be provided.

Referring now back to FIG. 6, GUI 600 is designed for adding/editing permissions 602 for one or more users 604. Permissions 606 for the user may be selected, for example, schema only, schema+single record, single+random sample, schema+smart sample, full data, and custom. When a sample is selected to be presented, a sample size 608 may be selected.

Referring now back to FIG. 7, GUI 700 presents a dataset in the format of a table 702, having column headers 704, and rows of data records 706 that include values for the columns. Table 702 is shown without application of permissions for hiding data. The actual values of the records 706 can be viewed by the user.

Referring now back to FIG. 8, GUI 800 presents table 702 described with reference to FIG. 7, to which permissions are applied. The permissions indicate visibility of the schema, while hiding all rows of data records (706 of FIG. 7). The hidden restricted data may be indicated, for example, by an overlay 802 that hides the underlying data. Column headers 704 of table 702 are visible. None of the data in records 706 shown in GUI 700 of FIG. 7 is visible to the user.

Referring now back to FIG. 9, GUI 900 presents a dataset in the format of a table 902, having column headers 904, and rows of data records 906 that include values for the columns. Table 902 is shown without application of permissions for hiding data. The actual values of the records 906 can be viewed by the user.

Referring now back to FIG. 10, GUI 1000 presents table 902 described with reference to FIG. 9, to which permissions are applied. The permissions indicate visibility of the schema, while hiding some rows of data records 906 of FIG. 9. The hidden restricted data may be indicated, for example, by an overlay 1002 that hides the underlying columns. Column headers 904 of table 902 of FIG. 9 are visible. The data in columns “Index”, “Field Name”, “Type”, and “Fully Type” 1004, as shown in records 906 of FIG. 9, is visible as per the permissions.

Referring now back to FIG. 11, GUI 1100 presents variables of a dataset, for example, column headers. A user may use GUI 1100 to select target variable 1102, for example, by clicking. As shown, the user selected target variable 1102 to be “price”.

Referring now back to FIG. 12, GUI 1200 indicates that the dataset shown in FIG. 11, which includes data of housing sales, is linked to the zipcode dataset 1202, and to a geospatial dataset 1204.

Referring now back to FIG. 13, GUI 1300 presents insight features 1302 generated by the hypothesis engine. Features 1302 may be ranked 1304 according to computed scores 1306 indicating correlation between the respective feature and the target variable. GUI 1300 may present other data, for example, direction of effect on the target variable 1308, train RIG, train support, feature missing values, a histogram, and the like.

Referring now back to FIG. 14, GUI 1400 presents additional detail for the insight feature “Degree-Pct of zipcode>=49.8”, which was the 4^{th} ranked insight feature in GUI 1300 of FIG. 13. GUI 1400 may be presented in response to a selection, for example a click, on an insight feature shown in GUI 1300 of FIG. 13. When no restrictions are applied, GUI 1400 may present data, for example, values of columns of sample records used to compute the selected insight features, and/or the corresponding value of the selected target variable. For example, samples values of target variable “price” 1402, the variable “zipcode” 1404 used to compute the insight features, and sample values of the computed insight feature 1406.

Referring now back to FIG. 15, GUI 1500 presents the additional detail for the insight feature “Degree-Pct of zipcode>=49.8”, as described with reference to FIG. 14. GUI 1500 depicts the effect of applying the restrictions that prohibit viewing any of the original data of the dataset, except the schema. This hides the same data of the dataset shown in GUI 1400 of FIG. 14, for example, by overlays 1502 that hide the underlying data. The user may view the column headers “price” 1402 of the target variable, “zipcode” 1404 used to compute the insight feature, and the header of the computed insight feature 1406, while hiding the sample data values.

Referring now back to FIG. 16, GUI 1600 presents additional detail for an example insight feature, without applying restrictions. The mathematical computation of the insight feature is expressed as getOrDefault(Census_Females-30-34_by_ZCTA, getOrDefault(Subscriber_Info_zipcode_by_subscriber_id, subscriber_id)) 1602. The mathematical representation is automatically converted to a more human readable feature 1604, Females-30-34 of zipcode of subscriber_id>=893. This is to allow a human who is unfamiliar with the codebase to better understand the insight feature. Human readable feature 1604 means that if the number of females in that age group is in the same neighborhood as the subscriber is larger than some value, it correlates with the target variable (in this example churning from a specific service). This is essentially the aggregated presentation of the insight feature that can be used. For clarity, GUI 1600 presents the additional details without applying restrictions. The additional details may include the computed values for the insight feature and/or the calculations leading to the values for the insight features. The permissions applied to the original dataset(s) may be propagated and applied to the additional details, for hiding the restricted data.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant datasets will be developed and the scope of the term dataset is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of dynamic adaptation of a graphical user interface (GUI) for exploring sensitive data, comprising:
dynamically creating a hidden data presentation by applying permissions to a dataset, for hiding a plurality of records;
obtaining a selection of a target variable via the GUI presenting the hidden data presentation;
feeding the dataset and the target variable into a hypothesis engine that extracts a plurality of hypothesis features from the dataset, tests correlations between the plurality of hypothesis features and the target variable, and selects a set of insight features from the plurality of hypothesis features according to the correlations;
dynamically creating a hidden result presentation by propagating the permission to the portions of the dataset used to compute the insight features; and
presenting within the GUI the hidden result presentation that presents the insight features and hides the portions of the dataset used to compute the insight features according to the permissions.

2. The computer implemented method of claim 1, wherein the dataset fed into the hypothesis engine includes data that is hidden during presentation of the hidden data presentation in the GUI.

3. The computer implemented method of claim 1, wherein the dataset comprises a primary dataset, the permissions comprise primary permissions, and further comprising:
creating at least one secondary hidden data presentation by applying secondary permissions to at least one secondary dataset, for hiding a plurality of secondary records, wherein each secondary dataset of a plurality of secondary datasets is associated with a different set of secondary permissions; and
presenting the at least one secondary hidden data presentation within the GUI,
wherein the at least one secondary dataset is fed with the primary dataset and the target variable into the hypothesis engine that extracts the plurality of hypothesis features from the at least one secondary dataset and the primary dataset.

4. The computer implemented method of claim 3, further comprising:
obtaining, via the GUI, a plurality of links between variables of the primary dataset and variables of the at least one secondary dataset, wherein variables linked by the plurality of links define a dynamic dataset;
wherein the dynamic dataset is fed into the hypothesis engine for extracting the plurality of hypothesis features from the dynamic dataset.

5. The computer implemented method of claim 1, further comprising converting an insight feature from a mathematical representation of computation of the insight feature, to a human readable text format, and presenting the human readable text format in the hidden result presentation.

6. The computer implemented method of claim 1, further comprising:
extracting at least one explanatory variable of the dataset used for computing the insight features, wherein propagating comprises applying the permissions to the at least one explanatory variable; and
presenting within the GUI the at least one explanatory variable with applied permissions.

7. The computer implemented method of claim 1, further comprising:
obtaining, via the GUI, at least one transformation applied to at least one variable of the dataset;
prior to the feeding, applying the at least one transformation to the dataset to obtain a transformed dataset;
presenting within the GUI, the at least one transformation and a presentation of the transformed dataset applied permissions; and
wherein feeding comprises feeding the transformed dataset into the hypothesis engine, wherein features are extracted from the transformed dataset.

8. The computer implemented method of claim 7, wherein the at least one transformation, the applying the at least one transformation, the feeding, the dynamically creating the hidden result presentation, and the presenting the hidden result presentation are dynamically iterated, wherein in each iteration a different adapted at least one transformation is obtained for generating adapted insight features.

9. The computer implemented method of claim 1, further comprising:
applying the insight features to the plurality of records of the dataset to obtain sets of extracted features;
creating a training dataset of a plurality of records, wherein a record of the training dataset includes a set of extracted features of a record of the dataset and ground truth of a value of the target variable of the record of the dataset; and
training a machine learning model on the training dataset.

10. The computer implemented method of claim 9, further comprising:
applying the insight features to input data to obtain extracted features for the input data;
feeding the extracted features of the input data into the machine learning model; and
obtaining a result value of the target variable as an outcome of the machine learning model.

11. The computer implemented method of claim 9, further comprising:
obtaining a new primary dataset having a schema of the primary dataset;
obtaining at least one new secondary dataset having a schema of at least one secondary dataset used to obtain the insight features;
applying permissions to the new primary dataset and the at least one new secondary dataset for hiding data during presentation;
linking the new primary dataset with the at least one new secondary dataset for creating a new dynamic dataset;
applying the insight features to the new dynamic dataset to obtain extracted features;
feeding the extracted features into the machine learning model; and
obtaining a result value of the target variable as an outcome of the machine learning model.

12. The computer implemented method of claim 1, wherein variables of the dataset to which permissions are applied are propagated to underlying data for computing the insight features, wherein the underlying data is hidden during presentation of the hidden result presentation in the GUI.

13. The computer implemented method of claim 1, wherein at least one insight feature computed by aggregating data from a subset of the plurality of records to which permissions are applied, is presented in the GUI without hiding.

14. The computer implemented method of claim 1, wherein insight features are not hidden and presented within the GUI, and values of the insight features computed from the dataset are hidden by propagating the permissions from the values of the dataset used to compute the values of the insight features to the values of the insight features.

15. The computer implemented method of claim 1, wherein the hypothesis engines extracts a plurality of hypothesis features by applying different combinations of functions to the datasets, and selects the set of insight features having a correlation above a threshold and/or having highest ranked correlations.

16. The computer implemented method of claim 1, further comprising:
obtaining, via the GUI, a selection of an insight feature computed from a portion of the dataset hidden according to the permissions, and
presenting, within the GUI, computed correlations between the selected insight feature and the target variable.

17. The computer implemented method of claim 1, wherein the insight features presented in the hidden result presentation include explanatory variables that explain changes in the target variable, while hiding values of the explanatory variable and hiding computations performed based on the explanatory variable.

18. The computer implemented method of claim 1, wherein permissions are defined according to user credentials.

19. The computer implemented method of claim 1, wherein the permissions are selected from a group consisting of: hiding all data of the dataset except for the data schema, partially hiding data of the dataset and allowing viewing of the other data, no hiding of any data of the dataset.

20. The computer implemented method of claim 1, wherein the dataset comprises a table of columns, and the permissions are defined for at least one of: the table as a whole, and per column.

21. A system for dynamic adaptation of a graphical user interface (GUI) for exploring sensitive data, comprising:
at least one processor executing a code for:
dynamically creating a hidden data presentation by applying permissions to a dataset, for hiding a plurality of records;
obtaining a selection of a target variable via the GUI presenting the hidden data presentation;
feeding the data and the target variable into a hypothesis engine that extracts a plurality of hypothesis features from the dataset, tests correlations between the plurality of hypothesis features and the target variable, and selects a set of insight features from the plurality of hypothesis features according to the correlations;
dynamically creating a hidden result presentation by propagating the permission to the portions of the dataset used to compute the insight features; and
presenting within the GUI the hidden result presentation that presents the insight features and hides the portions of the dataset used to compute the insight features according to the permissions.

22. A non-transitory medium storing program instructions for dynamic adaptation of a graphical user interface (GUI) for exploring sensitive data, which, when executed by at least one processor, cause the at least one processor to:
dynamically create a hidden data presentation by applying permissions to a dataset, for hiding a plurality of records;
obtain a selection of a target variable via the GUI presenting the hidden data presentation;
feed the data and the target variable into a hypothesis engine that extracts a plurality of hypothesis features from the dataset, tests correlations between the plurality of hypothesis features and the target variable, and selects a set of insight features from the plurality of hypothesis features according to the correlations;
dynamically create a hidden result presentation by propagating the permission to the portions of the dataset used to compute the insight features; and
present within the GUI the hidden result presentation that presents the insight features and hides the portions of the dataset used to compute the insight features according to the permissions.
